(19) United States
(12) Patent Application Publication
(10) Pub. No.: US 2009/0107409 A1
(43) Pub. Date: Apr. 30, 2009

(54) Container for transport and acclimation of fish and their acclimation to new environments

(76) Inventor: Charles Qian Yu, Sacramento, CA (US)

Correspondence Address: MATHEW J. TEMMERMAN, 423 E STREET, DAVIS, CA, 95616, US

(21) Appl. No.: 11/980,998

(22) Filed: Oct. 30, 2007

(51) Int. Cl. A01K 63/02

(52) U.S. Cl. 119/203

(57) ABSTRACT

A device for the transport, introduction, and acclimation of fish. The device, a bag comprising a window of dialysis membrane, allows fish to be transported within the bag and acclimated to new saline environments by allowing solutes, mainly salt and hydrogen ions, to slowly equilibrate between water within the bag and water in the source environment so as to avoid shock to the fish. Although the majority of the bag is impermeable to solutes, the dialysis membrane window is not, and is size dependent based on the characteristics of the fish to be acclimated. In use, the fish is placed in the bag along with source water from the source of the organism. The bag is then immersed in the destination aquarium, and passive diffusion allows the slow transport of solutes across the semi-permeable dialysis membrane, slowly equalizing the water parameters inside and outside the bag. After an appropriate amount of time has passed, the occupants of the container are removed and placed in the new environment.

### FIELD OF THE INVENTION

The present invention relates to the transport and introduction of fish to a new environment, specifically to producing a controlled rate of environment change in a fish environment, and hence a controlled rate of acclimation so as to reduce shock and stress to the fish during relocation.

### GENERAL BACKGROUND

Aquaria have been a component of society for millennia. Since the first fishkeeping during the Roman Empire, innovation has continued to bring about improvements both aesthetically and functionally.

One type of aquarium that developed over this time is the marine aquarium, built for housing marine plants and animals. The primary difference between marine aquaria and freshwater aquaria is the saltwater environment that must be maintained in a marine aquarium. Marine aquaria hold various fish, marine invertebrates, and other organisms that are important in scientific research and as a part of the hobby of aquarists. Hence, much innovation surrounds the improvement of marine aquaria, and presently the chemical condition of an aquarium can be precisely maintained for the more sensitive marine organisms that may be housed there.

Common measurements indicative of the chemical condition of the liquid environment in a marine aquarium include temperature, specific gravity (generally maintained between 1.020 and 1.026), salinity (a measure of the NaCl content of the water, generally maintained between 28 and 32 parts per thousand), pH (a measure of the hydrogen ion content of the water, generally between 8.1 and 8.3) and carbonate hardness (generally between 8 and 12 degrees). Other conditions that may be tested include calcium levels, alkalinity, iodine levels, strontium levels, molybdenum levels, and the levels of other trace materials. In addition, ammonia from organism waste and decaying matter is constantly being converted to nitrite and nitrate, and every aquarium has a different level of biological loading.

Because of differences in these and other water parameters, the environment varies from aquarium to aquarium. This presents a problem when a fish sensitive to subtle changes in environment is relocated from one aquarium to another. As we are an increasingly mobile society, many individuals and families relocate for work, school, or family. Oftentimes the fish must make the move as well. The move will oftentimes entail a first move to a temporary moving tank, and a second move to the new destination tank. Perhaps most importantly, whenever a fish is purchased the same moving steps must occur.

The shock experienced by the fish can cause grave injury, and worse, it can occur in a matter of minutes. The loss of the organism is not only emotionally and financially detrimental to the owner, but it can have an impact on the greater ecosystem as well, since to lose such organisms in captivity increases the demand on such organisms harvested from the wild, and consequently the environmental damage resulting from such harvesting.

To prevent such injuries, the original source water is often kept with the fish during transport. If the environment to which the fish is transported is not composed only of the source water from which the fish was taken, there will be some degree of mixing, and some degree of an environment change for the fish to withstand. To minimize the acclimation stress, as much of the source water as is practical is taken to the new location. Additionally, the new environment's parameters are often matched as closely as possible to the source environment. The three parameters generally recognized as most important are temperature, salinity, and pH.

Generally, the new environment cannot be exactly matched to the old. To further prevent injuries due to shock, fish should be slowly acclimated to their new environment so that the change is gradual and tolerable.

### DESCRIPTION OF THE PRIOR ART AND OBJECTIVES OF THE INVENTION

Methods and devices have been employed to further reduce the risk of shock to fish during transport from a first environment to a second. The traditional and most common method involves floating a container, generally a plastic bag in which the organism was transported, for a period of up to one hour in the new aquarium. This allows the water temperature inside and outside the bag to equilibrate. Water from the tank is then added to the bag in a slow, stepwise manner until the water within the bag more closely matches the water in the new aquarium. The fish are then removed from the bag and placed in the new environment. This method is often satisfactory, but requires a fair amount of work on the part of the person relocating the fish, and still subjects the fish to stepwise changes that may be stressful. It is not an ideal method.

An improvement upon the technique outlined above is similar, except the step-wise addition of water is replaced with the slow siphoning of water through small caliber tubing. This allows water from the new aquarium to slowly mix with water in the transport bag. This technique is not without its drawbacks either. There is a high risk of overflowing the transport container if it is left unattended, resulting in a damaging spill of salt water and possible loss of the fish. It is also difficult to assess the proper flow rate for the siphon, which can lead to overly fast changes in water parameters.

Several devices have been disclosed that also attempt to address these problems. U.S. Pat. No. 4,188,909 (Spivak) discloses a plastic device comprising multiple separate chambers into which water and the fish from the source aquarium are placed. The device is then placed along an inside wall of the new aquarium. A quantity of water is poured into a separate chamber on the device. Then, via a valve, water from the separate chamber is allowed to slowly enter the chamber containing the marine organism being relocated. Once the gradual dilution of source aquarium water is complete, and the temperature has equalized to that of the water in the destination aquarium, the device may be opened to allow the inhabitant to swim out.

Spivak operates similarly to the second technique described above, and suffers from some of the same drawbacks. Additionally, this technique allows water from the source aquarium to mix with water from the destination aquarium. Mixing of this sort is generally avoided by aquarists because it increases the chance that pathogens may enter the destination aquarium. Additionally, the device is large and bulky and may not fit on many aquarium installations. Finally, the device requires user input in operating the valve, increasing the chance for error. Drop by stepwise introduction of water is disclosed again in U.S. Pat. No. 6,640,749 to Monnier.

Another device that addresses this problem is disclosed in U.S. Pat. No. 3,491,722 (Levitov et al.). Levitov et al. describe a device that allows for the controlled intermingling of destination aquarium water with transport water by partially submerging the fish and their water in a plastic chamber in the destination aquarium. This device also works similarly to the second technique described above, and solves the problems of step-wise changes and possible overflow. However, it again requires operator adjustment and thus may result in mixing occurring to quickly. Also, the device again allows mixing of source water and destination water. Finally, this device is bulky and may not fit in many aquariums.

Dialysis membranes have not been used to solve the aforementioned problem of fish acclimation. Dialysis membranes have been used in filtration systems, however, as described in U.S. Pat. No. 5,433,843 (Calabrese). A dialysis membrane, like other semi-permeable membranes, is composed of materials such that the porosity of the membrane allows only molecules smaller than a certain molecular weight to pass. When the membrane is submerged, water and solutes smaller than this molecular weight cut off can diffuse across the membrane, while solutes larger this molecular weight cut off cannot. When dry on at one side no solutes or water can pass through the membrane. This type of membrane has been used in laboratory applications mainly for the exchange of buffers. The membrane's applicability to the present problem has never been discussed.

It is thus an objective of the present invention to provide a means for the acclimation of relocated fish in a manner that will minimize the level of shock experienced by the fish.

It is a second object of the present invention to provide a means for the acclimation of relocated fish that also functions as the transport container for those fish.

It is a third objective of the present invention to provide a simple means for the acclimation of relocated fish that requires no user adjustments.

It is a fourth objective of the present invention to provide a means for the acclimation of relocated fish that is small enough to fit in nearly any aquarium installation.

It is a fifth objective of the present invention to maximize survival of fish in captivity so as to reduce the demand for harvesting these organisms from the wild, and the environmental damage that results from such harvesting.

Additional objects and advantages of the present invention will become obvious to the reader and it is intended that these objects and advantages be within the scope of the present invention.

### BRIEF DESCRIPTION OF THE FIGURES

The foregoing aspects and many of the attendant advantages of the invention will become more readily appreciated as the same becomes better understood by reference to the following detailed description, when taken in conjunction with the accompanying drawings, wherein:

FIG. 1 is an environmental perspective view of a container for transport and acclimation of fish according to a preferred embodiment of the invention. Cross-sectional lines taken along 2-2 and 3-3 are depicted;

FIG. 2 is a cross-sectional view taken along cutline 2-2 in FIG. 1;

FIG. 3 is a cross-sectional view taken along cutline 3-3 in FIG. 1;

FIG. 4 is an enlarged view of the area circled and labeled in FIG. 3; while

FIG. 5 is a cross-sectional environmental view of the present invention in use.

### SUMMARY OF THE INVENTION

The present invention relates to marine aquaria which house a diverse range of fish. A device for the transport, introduction, and acclimation of fish is disclosed. The device, a containment vessel, at least a portion of which comprises dialysis membrane, allows fish to be transported and acclimated to new saline environments by allowing solutes to slowly equilibrate so as to avoid shock to the fish.

Although in a preferred embodiment a majority of the vessel is impermeable to solutes, the dialysis membrane window is a portion, size dependent on the characteristics of the fish to acclimated, wherein passive diffusion of the solutes occurs.

In use, the fish is placed in the vessel along with source water from the source of the organism. The vessel is then immersed in the destination aquarium, and passive diffusion allows the slow transport of solutes across the semi-permeable dialysis membrane. After an appropriate amount of time has passed, water parameters inside and outside the vessel will have equalized and the occupants of the container are removed and placed in the new environment.

### DETAILED DESCRIPTION OF THE INVENTION

A device for the transport, introduction, and acclimation of fish is disclosed. The device, a containment vessel or bag, at least a portion of which comprises dialysis membrane, allows fish to be transported and acclimated to new saline environments by allowing solutes to slowly equilibrate so as to avoid shock to the fish.

For purposes of this document, source aquarium refers to the original aquarium from which a fish to be relocated was taken. The destination or new aquarium is the environment to which the fish is being moved.

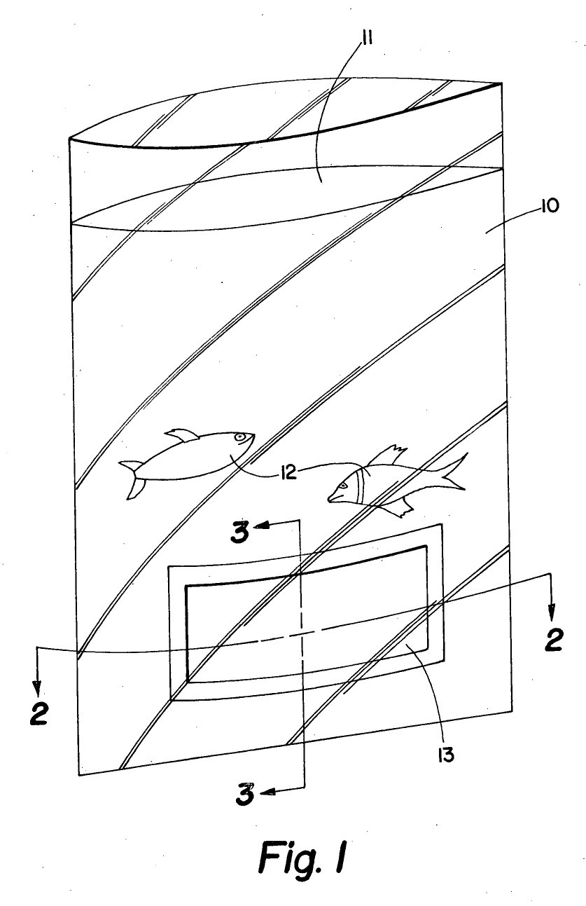

Referring first to FIG. 1, the device comprises a transport vessel, preferably plastic bag 10 that is filled with source water 11 and fish 12. An area of the plastic bag is removed and replaced with a semi permeable dialysis membrane 13, such as a visking membrane available through Medicell International Ltd. of London, England. In a preferred embodiment, the dialysis membrane will retain materials having a molecular weight of approximately 6000 Daltons or higher, however in alternative embodiments the maximum would vary to as low as 200 Daltons or as high as 2 megaDaltons. With a cutoff at this weight, contaminants such as bacteria, protozoa, viruses, and most proteins and sugars would not be able to pass through the membrane, but small electrolytes and ions that determine the important water parameters would.

The size of the dialysis membrane 13 window may vary depending on the sensitivity of the fish involved. For a less sensitive fish, a larger window may be used, thus increasing the rate of solute transfer. On one end of the continuum, a window having a surface area of only a small fraction of the surface area of the plastic bag may be used, while on the other end of the continuum, up to 95% of the plastic bag could be replaced with dialysis membrane.

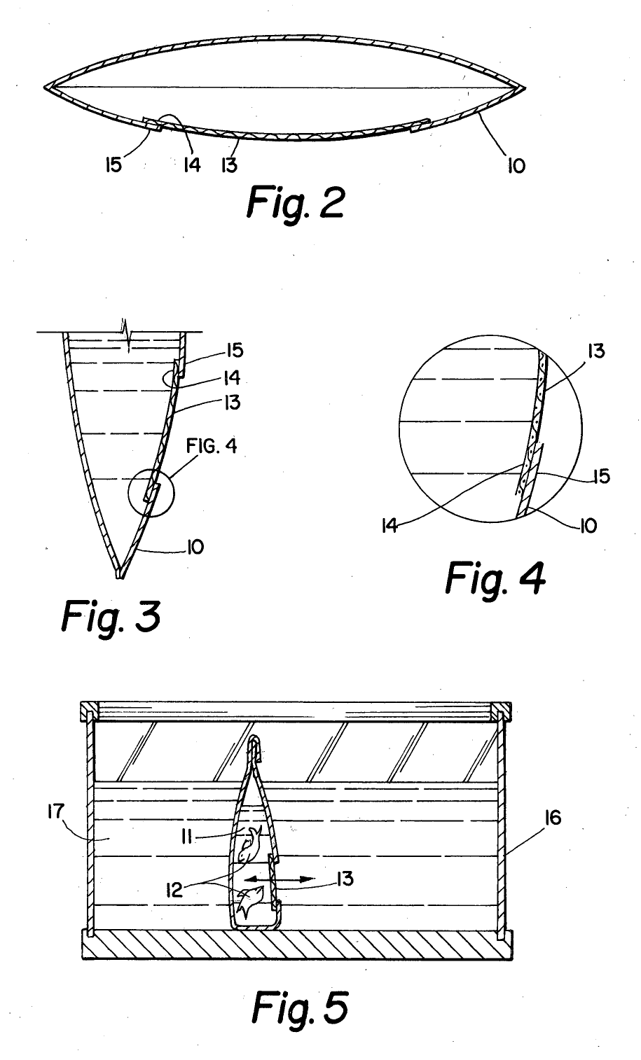

In a preferred embodiment and as shown in FIGS. 2-4, membrane 13 has a membrane overlapping portion 14 that matches against and overlaps with a bag overlapping portion 15. It is at the location of these two overlapping portions where plastic bag 10 and dialysis membrane 13 are joined. Membrane overlapping portion 14 is affixed to the plastic bag either through a non-toxic adhesive, heat-sealing, or a combination of both. A watertight seal is of paramount importance and there are numerous conventional methods in the art for achieving this. Although in FIG. 1 the bag contains no closure device, the user may add a closure device in alternative embodiments as deemed appropriate.

Referring now to FIG. 5, the device is shown submerged in a destination aquarium 16. Source water 11 within plastic bag 10 is kept separate from destination water 17 contained in the destination aquarium. A two way arrow in FIG. 5 depicts the movement of solutes from the source water 11 to the destination water 17 and vice versa.

Because the dialysis membrane is impermeable to water when dry on at least one side, the device may be used not only for the gradual acclimation of fish, but also may be used for fish transport. In fact, the device may be used for the transport of fish just as one would use an ordinary plastic bag.

In use, source water 11 from a source tank or aquarium (not shown) along with the fish to be relocated are placed in the device. For easier transport, the top may be tied off with a rubber band (not shown). The fish and source water 11 is then transported to the destination aquarium 16. See FIG. 5. Once at the destination, the bag may be rinsed off to remove any dust that has attached during transport. The entire device is then placed into the destination aquarium 16 as shown. The dialysis membrane 13 window is now submerged on both sides, allowing solutes to begin equalizing across the semi-permeable membrane. NaCl, hydrogen ions, and other small molecules can move slowly across the membrane down their concentration gradients. The effect on the environments is a gentle and gradual change in salinity and pH. Simultaneously, the temperature equalizes. Contaminants such as bacteria, viruses, and protozoa cannot cross into the destination aquarium.

In a preferred embodiment, after several hours to a day, the chemical composition and temperature of the source water 11 will be equilibrated with the chemical composition and temperature of the destination water 17. At this point in the process, the device can be removed from the aquarium and the fish can be transferred to the destination aquarium 16.

In use, the device provides a means for the acclimation of relocated fish in a manner that will minimize the shock experienced by the fish. Although in a preferred embodiment the means has been described to apply to fish, other small marine organisms can benefit as well, in the same manner as has been described in relation to fish. The means described is simple and requires no user adjustments to operate, and is small enough to fit in nearly any aquarium. The device and means dramatically reduces contaminants being introduced to the new environment. Finally, by maximizing the lifespan of fish in captivity, the demand on harvested fish from the wild is reduced.

With respect to the above description then, it is to be realized that material disclosed in the applicant's drawings and description may be modified in certain ways while still producing the same result claimed by the applicant. Such variations are deemed readily apparent and obvious to one skilled in the art, and all equivalent relationships to those illustrated in the drawings and equations and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact disclosure shown and described, and accordingly, all suitable modifications and equivalents may be resorted to, falling within the scope of the invention.

1. A method of relocating a fish from a source aquarium to a destination aquarium, the method comprising the steps of:
a. placing source water and a fish from said source aquarium inside a transport vessel, the transport vessel further comprising:
i. a semipermeable membrane window;
b. transporting said transport vessel from said source aquarium to said destination aquarium, wherein said destination aquarium comprises destination water;
c. placing said transport vessel in said destination aquarium such that said dialysis membrane window is at least partially submerged in said destination aquarium;
d. equalizing solutes and temperature between said source water within said transport vessel and said destination water; and
e. releasing said fish into said destination aquarium, said releasing step occurring after said equalizing step.

2. The method of relocating a fish according to claim 1 wherein a part of said solute transfer occurs through passive diffusion.

3. The method of relocating a fish according to claim 1 wherein said semipermeable membrane window is a dialysis membrane window.

4. The method of relocating a fish according to claim 3 wherein said transport vessel is at least 50 milliliters in capacity and wherein said source aquarium and said destination aquarium are at least 1 liter in capacity.

5. The method of relocating a fish according to claim 4 wherein said dialysis membrane window has a surface area at least 50% bag surface area.

6. The method of relocating a fish according to claim 4 wherein said dialysis membrane window has a surface area at most 50% bag surface area.

7. The method of relocating a fish according to claim 1 wherein said semipermeable membrane window has a molecular weight cut-off of between 200 Daltons and 2 megaDaltons.

8. The method of relocating a fish according to claim 7 wherein said transport vessel is at least 50 milliliters in capacity and wherein said source aquarium and said destination aquarium are at least 1 liter in capacity.

9. The method of relocating a fish according to claim 8 wherein said semipermeable membrane window has a surface area at least 50% bag surface area.

10. The method of relocating a fish according to claim 8 wherein said semipermeable membrane window has a surface area at most 50% bag surface area.

11. A means for the relocation of a fish from source water to destination water, the means comprising the steps of:
a. placing a fish and source water in a bag comprising a semipermeable membrane, the source water in said bag having a bag temperature, and comprising first bag solutes and second bag solutes;
b. moving said bag from said source water to said destination water, said destination water having a destination temperature and destination solutes;
c. substantially equalizing said bag temperature with said destination temperature and said first bag solutes with said destination solutes, while substantially blocking the passage of said second bag solutes into said destination water; and
d. releasing said fish into said destination water.

12. The method of relocating a fish according to claim 11 wherein a part of said solute equalizing occurs through passive diffusion.

13. The method of relocating a fish according to claim 11 wherein said semipermeable membrane window has a molecular weight cut-off of between 200 Daltons and 2 megaDaltons.

14. The method of relocating a fish according to claim 13 wherein said transport vessel is at least 50 milliliters in capacity and wherein said source aquarium and said destination aquarium are at least 1 liter in capacity.

15. The method of relocating a fish according to claim 14 wherein said semipermeable membrane window has a surface area at least 50% bag surface area.

16. The method of relocating a fish according to claim 14 wherein said semipermeable membrane window has a surface area at most 50% bag surface area.

17. A means for the relocation of a fish from a first aquarium to a second aquarium, the means comprising the steps of:
a. placing a fish and source water from said first aquarium inside a transport vessel, at least a portion of said transport vessel comprising a semi permeable membrane with a molecular weight cut-off of between 200 Daltons and 2 megaDaltons;
b. at least partially submerging said transport vessel in said second aquarium such that solutes transfer across a said semipermeable membrane from said source water to said second aquarium and vice versa; and
c. releasing said fish from said transport vessel to said second aquarium.

18. The method of relocating a fish according to claim 17 wherein said transport vessel is at least 50 milliliters in capacity and wherein said aquariums are at least 1 liter in capacity.

19. The method of relocating a fish according to claim 18 wherein said semipermeable membrane window has a surface area at least 50% bag surface area.

20. The method of relocating a fish according to claim 19 wherein said semipermeable membrane window has a surface area at most 50% bag surface area.
